(19) United States
(12) Patent Application Publication
(10) Pub. No.: US 2024/0405222 A1
(43) Pub. Date: Dec. 5, 2024

(54) ANODE ELECTRODE, MANUFACTURING METHOD THEREOF AND SECONDARY BATTERY USING THE SAME

(71) Applicant: RESEARCH & BUSINESS FOUNDATION SUNGKYUNKWAN UNIVERSITY, Suwon-si (KR)

(72) Inventors: Ho Seok PARK, Seongnam-si (KR); Sang Ha BAEK, Suwon-si (KR); Jin Suk BYUN, Uijeongbu-si (KR)

(73) Assignee: RESEARCH & BUSINESS FOUNDATION SUNGKYUNKWAN UNIVERSITY, Suwon-si (KR)

(21) Appl. No.: 18/678,394

(22) Filed: May 30, 2024

(30) Foreign Application Priority Data
May 30, 2023 (KR) 10-2023-0069223

(51) Int. Cl. H01M 4/60; H01M 4/02; H01M 4/04

(52) U.S. Cl. CPC H01M 4/602; H01M 4/0404; H01M 2004/027

(57) ABSTRACT

According to the present invention, a method for manufacturing a negative electrode includes: preparing a metal electrode, polyoxometalate (POM), and a solvent; preparing a composite coating layer source solution by mixing the POM and the solvent; and preparing a composite coating layer by providing and drying the composite coating layer source solution on the metal electrode.

### BACKGROUND OF THE INVENTION

### 1. Field of the Invention

The present invention relates to a negative electrode, a method for manufacturing the same, and a secondary battery using the same, and more particularly, to a negative electrode including a polymer matrix and polyoxometalate (POM) dispersed in the polymer matrix, a method for manufacturing the same, and a secondary battery using the same.

### 2. Description of the Related Art

The initial growth of the global secondary battery market was led by small IT devices such as smartphones. However, recently, the vehicle secondary battery market has been growing rapidly due to the growth of the electric vehicle market.

Vehicle secondary batteries are leading the growth of the electric vehicle market by achieving low prices and performance stabilization with mass production and technology development through product standardization. In addition, the market is rapidly expanding as the short traveling range, which was pointed out as a limitation of electric vehicles, has been resolved through improvements in battery performance.

As the demand for secondary batteries is increasing explosively, the development of next-generation secondary batteries is also being actively conducted in response to safety issues of secondary batteries and demands for increased battery capacities.

For example, Korean Patent Registration No. 10-1788232 discloses a secondary battery electrode, in which a current collector is coated with an electrode mixture including an electrode active material and a binder, the secondary battery electrode including: a first electrode mixture layer including a first binder having a glass transition temperature (Tg) that is lower than a glass transition temperature (Tg) of a second binder and an electrode active material, in which the current collector is coated with the first electrode mixture layer; and a second electrode mixture layer including the second binder having the glass transition temperature (Tg) that is higher than the glass transition temperature (Tg) of the first binder and an electrode active material, in which the first electrode mixture layer is coated with the second electrode mixture layer, wherein the glass transition temperature (Tg) of the first binder is less than or equal to 15° C., the glass transition temperature (Tg) of the second binder is greater than or equal to 10° C. while being higher than the glass transition temperature of the first binder, the glass transition temperature (Tg) of the second binder is greater than or equal to 10° C. and less than 25° C. while being higher than the glass transition temperature of the first binder, the secondary battery electrode is a negative electrode, and the electrode active material includes a Si-based material.

### SUMMARY OF THE INVENTION

One technical object of the present invention is to provide a method for manufacturing a negative electrode, capable of suppressing a side reaction.

Another technical object of the present invention is to provide a method for manufacturing a negative electrode, capable of suppressing formation of dendrite.

Still another technical object of the present invention is to provide a method for manufacturing a negative electrode, capable of reducing a manufacturing process cost.

Yet another technical object of the present invention is to provide a method for manufacturing a negative electrode, capable of shortening a manufacturing time.

Still yet another technical object of the present invention is to provide a method for manufacturing a negative electrode, capable of facilitating mass production.

Technical objects of the present invention are not limited to the above-described technical objects.

To achieve the technical objects described above, the present invention provides a method for manufacturing a negative electrode.

According to one embodiment, the method for manufacturing the negative electrode includes: preparing a metal electrode, polyoxometalate (POM), and a solvent; preparing a composite coating layer source solution by mixing the POM and the solvent; and preparing a composite coating layer by providing and drying the composite coating layer source solution on the metal electrode.

According to one embodiment, the solvent may include an ion conductive polymer and deionized water, and a volume ratio of the ion conductive polymer and the deionized water may be greater than 1.5:1 and less than 9:1.

According to one embodiment, a weight of the POM per a volume of the solvent may be greater than 300 g/L and less than 500 g/L.

According to one embodiment, the POM may include one of molybdenum (Mo), tungsten (W), or vanadium (V).

According to one embodiment, the solvent may include one of polyethylene glycol dimethyl ether, polyacrylonitrile, poly DOL, polyamide, polyacrylic acid, or polyphthalocyanine.

According to one embodiment, the metal electrode may include one of zinc (Zn), lithium (Li), sodium (Na), magnesium (Mg), potassium (K), or calcium (Ca).

To achieve the technical objects described above, the present invention provides a negative electrode manufactured by the manufacturing method described above.

According to one embodiment, the negative electrode includes: a metal electrode; and a composite coating layer formed on the metal electrode, wherein the composite coating layer includes a polymer matrix and polyoxometalate (POM) dispersed in the polymer matrix.

According to one embodiment, when X-ray photoelectron spectroscopy (XPS) measurement for the POM of the composite coating layer is performed, a proportion of an ion of a central metal of the POM, which has a second oxidation number that is higher than a first oxidation number, may be higher than a proportion of an ion of the central metal of the POM, which has the first oxidation number.

According to one embodiment, the central metal of the POM may be molybdenum (Mo), the first oxidation number may be +5, and the second oxidation number may be +6.

According to one embodiment, the POM may have one structure among a Keggin structure, a Dawson structure, or an Anderson structure.

According to one embodiment, when three-dimensional microscopy measurement for the composite coating layer is performed, an arithmetic mean height (Sa) value corresponding to surface roughness of the composite coating layer may be less than or equal to 0.629 um.

To achieve the technical objects described above, the present invention provides a secondary battery to which the negative electrode described above is applied.

According to one embodiment, the secondary battery includes: the negative electrode described above; a positive electrode formed on the negative electrode; and an electrolyte formed between the negative electrode and the positive electrode, wherein, during a charging/discharging process, due to plating and stripping of a metal ion of a same type as the metal electrode of the negative electrode, a metallization layer obtained by the plating of the metal ion is formed on the metal electrode, and a passivation layer is formed on the metallization layer, and the metallization layer and the passivation layer include the POM and the polymer matrix of the composite coating layer.

According to one embodiment, during plating and stripping processes of the metal ion, formation of dendrite on the metal electrode may be suppressed.

According to an embodiment of the present invention, a method for manufacturing a negative electrode may include: preparing a metal electrode, polyoxometalate (POM), and a solvent; preparing a composite coating layer source solution by mixing the POM and the solvent; and preparing a composite coating layer by providing and drying the composite coating layer source solution on the metal electrode.

The solvent may include an ion conductive polymer and deionized water, which alleviate a strongly acidic characteristic of the POM.

In detail, a volume ratio of the ion conductive polymer and the deionized water may be controlled to be greater than 1.5:1 and less than 9:1, and a weight of the POM per a volume of the solvent may be controlled to be greater than 300 g/L and less than 500 g/L, so that the composite coating layer with reduced surface roughness can be provided on the metal electrode.

Accordingly, according to an embodiment of the present invention, the manufactured negative electrode may include the metal electrode, a polymer matrix formed on the metal electrode and including the ion conductive polymer, and the POM dispersed in the polymer matrix.

The POM can suppress a side reaction during a charging/discharging process, and the POM and the polymer matrix can reduce a transfer resistance of a metal ion of the same type as the metal electrode.

Therefore, during the charging/discharging process, the side reaction can be suppressed by the POM of the composite coating layer, so that a side reactant on the metal electrode can be minimized. Accordingly, electrical characteristics of a secondary battery to which the negative electrode is applied can be improved.

In addition, the POM and the polymer matrix can reduce the transfer resistance of the metal ion, so that plating and stripping of the metal ion on the metal electrode can be facilitated during the charging/discharging process. Accordingly, growth of dendrite on the metal electrode can be suppressed, so that a metallization layer obtained by the plating of the metal ion can be substantially uniformly formed on the metal electrode, and a passivation layer can be substantially uniformly formed on the metallization layer. Accordingly, long-term stability of the secondary battery over charging/discharging cycles can be improved.

### BRIEF DESCRIPTION OF THE DRAWINGS

FIG. 1 is a flowchart for describing a method for manufacturing a negative electrode according to an embodiment of the present invention.

FIG. 2 is a view for describing a metal electrode, polyoxometalate (POM)), and a solvent according to the embodiment of the present invention.

FIG. 3 is a view for describing a method for preparing the solvent by using an ion conductive polymer and deionized water according to the embodiment of the present invention.

FIG. 4 is a view for describing a method for preparing a composite coating layer source solution by mixing and stirring the POM and the solvent according to the embodiment of the present invention.

FIG. 5 is a view for describing a method for preparing a composite coating layer by providing the composite coating layer source solution on the metal electrode according to the embodiment of the present invention.

FIG. 6 is a view for describing the negative electrode according to the embodiment of the present invention after applying the negative electrode to a secondary battery and performing charging/discharging.

FIG. 7A is a photograph of a surface of a negative electrode according to Experimental Example 2 of the present invention.

FIG. 7B is a photograph of a surface of a negative electrode according to Experimental Example 1 of the present invention.

FIG. 8A is an SEM photograph of the negative electrode according to Experimental Example 2 of the present invention.

FIG. 8B is an SEM photograph of the negative electrode according to Experimental Example 1 of the present invention.

FIG. 9A is a photograph for analyzing surface roughness of the surface of the negative electrode according to Experimental Example 2 of the present invention by using a three-dimensional measurement device.

FIG. 9B is a photograph for analyzing surface roughness of the surface of the negative electrode according to Experimental Example 1 of the present invention by using the three-dimensional measurement device.

FIG. 10 shows a result of analyzing the negative electrode according to Experimental Example 1 of the present invention through high resolution transmission electron microscopy (HRTEM).

FIGS. 11A and 11B are SEM photographs of a negative electrode according to Comparative Example of the present invention after manufacturing a symmetric cell with the negative electrode and performing charging/discharging cycles.

FIGS. 11C and 11D are SEM photographs of a negative electrode according to Experimental Example 2 of the present invention after manufacturing a symmetric cell with the negative electrode and performing charging/discharging cycles.

FIGS. 11E and 11F are SEM photographs of a negative electrode according to Experimental Example 1 of the present invention after manufacturing a symmetric cell with the negative electrode and performing charging/discharging cycles.

FIG. 12A is a 3D laser scanning microscope (3DLSM) photograph of the negative electrode according to Comparative Example of the present invention after manufacturing the symmetric cell with the negative electrode and performing the charging/discharging cycles.

FIG. 12B is a 3DLSM photograph of the negative electrode according to Experimental Example 1 of the present invention after manufacturing the symmetric cell with the negative electrode and performing the charging/discharging cycles.

FIG. 13 is an XRD graph for comparing side reactants generated in the negative electrodes according to Comparative Example and Experimental Examples of the present invention after manufacturing the symmetric cells with the negative electrodes and performing the charging/discharging cycles.

FIG. 14A is a graph obtained by manufacturing Zn∥Cu cells with the negative electrodes according to Comparative Example and Experimental Example 1 of the present invention and performing measurement through cyclic voltammetry (CV).

FIG. 14B is a graph obtained by manufacturing Zn∥Cu cells with the negative electrodes according to Comparative Example and Experimental Examples of the present invention and performing analysis through electrochemical impedance spectroscopy (EIS).

FIG. 14C is a graph obtained by manufacturing the Zn∥Cu cells with the negative electrodes according to Comparative Example and Experimental Example 1 of the present invention and showing a Tafel plot.

FIGS. 15A and 15B are graphs for comparing long-term stability of the symmetric cells according to Comparative Example and Experimental Example 1 by manufacturing the symmetric cells with the negative electrodes according to Comparative Example and Experimental Example 1 of the present invention.

FIG. 16 is a graph showing a cumulative capacity according to a current density to compare the symmetric cell manufactured with the negative electrode having a composite coating layer according to Experimental Example 1 of the present invention and symmetric cells manufactured with negative electrodes having coating layers according to Experimental Modification Examples.

FIG. 17A is a graph obtained by manufacturing a full cell with the negative electrode according to Comparative Example of the present invention and performing measurement through cyclic voltammetry (CV) for each scan rate.

FIG. 17B is a graph obtained by manufacturing a full cell with the negative electrode according to Experimental Example 1 of the present invention and performing measurement through CV for each scan rate.

FIG. 18 is a graph obtained by manufacturing the full cells with the negative electrodes according to Comparative Example and Experimental Example 1 of the present invention and performing analysis through electrochemical impedance spectroscopy (EIS).

FIG. 19A is an SEM photograph of the negative electrode of the full cell according to Comparative Example of the present invention after manufacturing the full cell with the negative electrode according to Comparative Example of the present invention and performing charging/discharging cycles.

FIG. 19B is an SEM photograph of the negative electrode of the full cell according to Experimental Example 1 of the present invention after manufacturing the full cell with the negative electrode according to Experimental Example 1 of the present invention and performing charging/discharging cycles.

FIG. 20A is a photograph of a composite coating layer on a metal electrode of a negative electrode according to Experimental Modification Example of the present invention.

FIG. 20B is a photograph of a composite coating layer source solution according to Experimental Modification Example of the present invention.

FIGS. 21A to 21E are photographs obtained by capturing processes of manufacturing negative electrodes and the manufactured negative electrodes according to Experimental Example 2 and Experimental Modification Examples of the present invention.

FIG. 22 is a graph obtained by manufacturing symmetric cells with the negative electrodes according to Comparative Example, Experimental Example 2, and Experimental Modification Examples of the present invention and performing measurement through chronopotentiometry (CP).

FIGS. 23A to 23C and 23E are photographs of the processes of manufacturing the negative electrodes and the manufactured negative electrodes according to Experimental Modification Examples of the present invention.

FIG. 23D is a photograph of a process of manufacturing a negative electrode and the manufactured negative electrode according to Experimental Example 1 of the present invention.

FIG. 24 is a graph obtained by manufacturing symmetric cells with the negative electrodes according to Experimental Example 1 and Experimental Modification Examples of the present invention and performing measurement through chronopotentiometry (CP).

FIGS. 25A to 25D are graphs for analyzing the negative electrodes according to Comparative Example and Experimental Examples of the present invention through X-ray photoelectron spectroscopy (XPS).

FIGS. 26A to 26F are graphs for analyzing the negative electrodes according to Comparative Example and Experimental Examples of the present invention through secondary ion mass spectrometry (SIMS).

### DETAILED DESCRIPTION OF THE INVENTION

Hereinafter, exemplary embodiments of the present invention will be described in detail with reference to the accompanying drawings. However, the technical idea of the present invention is not limited to the embodiments described herein, but may be embodied in different forms. The embodiments introduced herein are provided to sufficiently deliver the idea of the present invention to those skilled in the art so that the disclosed contents may become thorough and complete.

When it is mentioned in the present disclosure that one element is on another element, it means that one element may be directly formed on another element, or a third element may be interposed between one element and another element. Further, in the drawings, thicknesses of films and regions are exaggerated for effective description of the technical contents.

In addition, although the terms such as first, second, and third have been used to describe various elements in various embodiments of the present disclosure, the elements are not limited by the terms. The terms are used only to distinguish one element from another element. Therefore, an element mentioned as a first element in one embodiment may be mentioned as a second element in another embodiment. The embodiments described and illustrated herein include their complementary embodiments, respectively. Further, the term “and/or” used in the present disclosure is used to include at least one of the elements enumerated before and after the term.

As used herein, an expression in a singular form includes a meaning of a plural form unless the context clearly indicates otherwise. Further, the terms such as “including” and “having” are intended to designate the presence of features, numbers, steps, elements, or combinations thereof described herein, and shall not be construed to preclude any possibility of the presence or addition of one or more other features, numbers, steps, elements, or combinations thereof. In addition, the term “connection” used herein is used to include both indirect and direct connections of a plurality of elements.

Further, in the following description of the present invention, detailed descriptions of known functions or configurations incorporated herein will be omitted when they may make the gist of the present invention unnecessarily unclear.

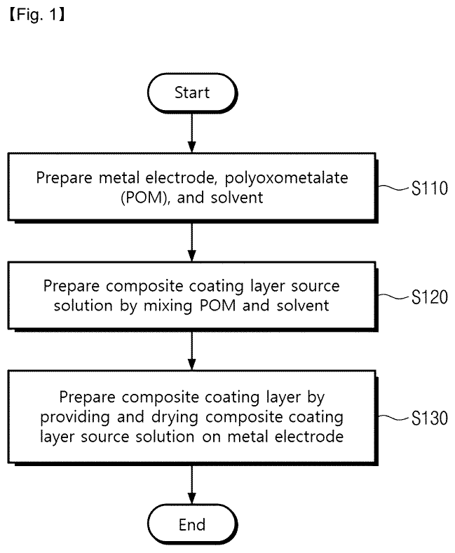

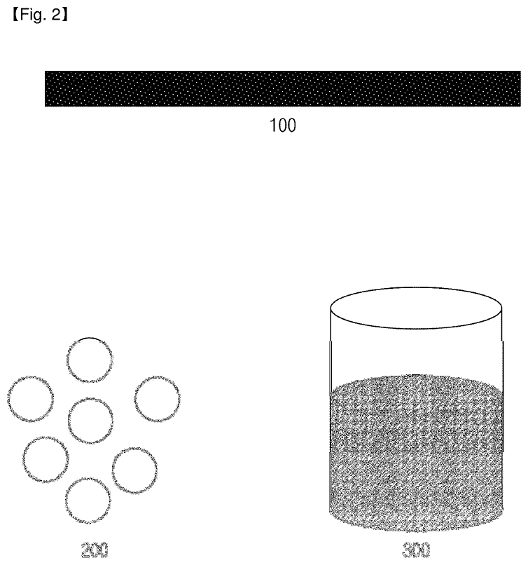

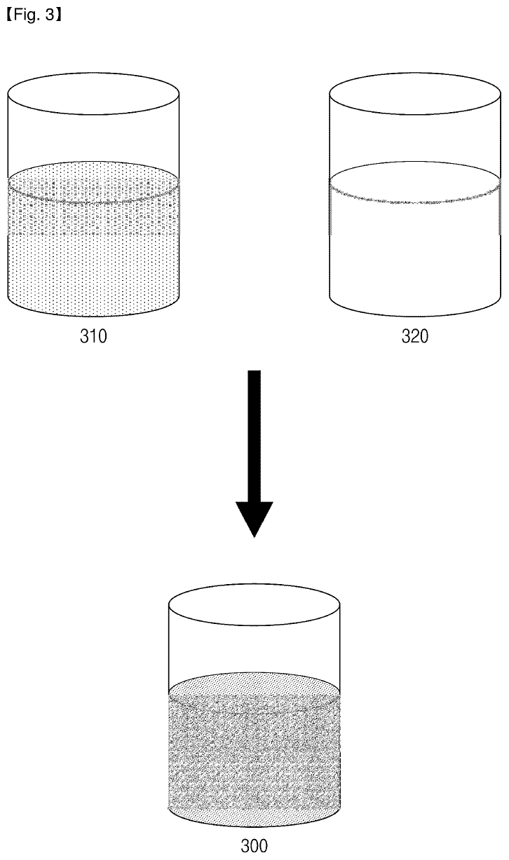

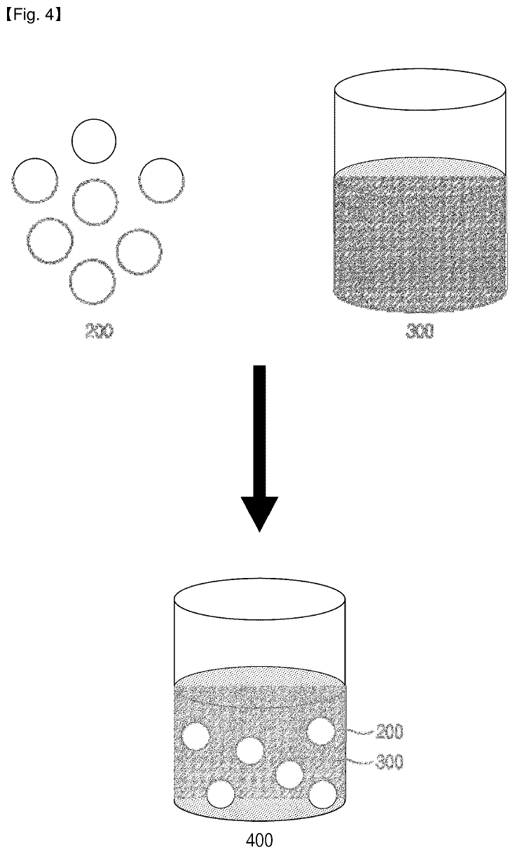

FIG. 1 is a flowchart for describing a method for manufacturing a negative electrode according to an embodiment of the present invention, FIG. 2 is a view for describing a metal electrode, polyoxometalate (POM), and a solvent according to the embodiment of the present invention, FIG. 3 is a view for describing a method for preparing the solvent by using an ion conductive polymer and deionized water according to the embodiment of the present invention, FIG. 4 is a view for describing a method for preparing a composite coating layer source solution by mixing and stirring the POM and the solvent according to the embodiment of the present invention, FIG. 5 is a view for describing a method for preparing a composite coating layer by providing the composite coating layer source solution on the metal electrode according to the embodiment of the present invention, and FIG. 6 is a view for describing the negative electrode according to the embodiment of the present invention after applying the negative electrode to a secondary battery and performing charging/discharging.

Referring to FIGS. 1 and 2, a metal electrode 100, polyoxometalate (POM) 200, and a solvent 300 may be prepared (S110).

The metal electrode 100 may be, for example, one of zinc (Zn), lithium (Li), sodium (Na), magnesium (Mg), potassium (K), or calcium (Ca).

The POM 200 may have one of a Keggin structure, a Dawson structure, or an Anderson structure. For example, a central metal of the POM 200 may be one of molybdenum (Mo), tungsten (W), or vanadium (V).

The POM 200 may enable non-plating and non-stripping of a metal ion of the same type as the metal electrode 100 during a charging/discharging process. In other words, the POM 200 may not perform a function of an active material that electrochemically plates and strips the metal ion.

In addition, the POM 200 may minimize a side reactant by suppressing a side reaction occurring on the metal electrode 100 during the charging/discharging process.

Meanwhile, the POM 200 may have a strongly acidic characteristic. When an ion conductive polymer 310 and/or deionized water 320, which will be described below, are omitted in the solvent 300, due to the strongly acidic characteristic of the POM 200, the POM 200 and the metal electrode 100 may react with each other, and as a result, surface roughness of a composite coating layer 500, which will be described below, on the metal electrode 100 may be increased.

The solvent 300 may include the ion conductive polymer 310 and the deionized water 320.

The ion conductive polymer 310 may alleviate the strongly acidic characteristic of the POM 200. Therefore, when the composite coating layer 500 is prepared by mixing the ion conductive polymer 310 and the solvent 300 including the POM 200, a reaction between the POM 200 and the metal electrode 100 may be minimized, so that the surface roughness of the composite coating layer 500 formed on the metal electrode 100 may be decreased. For example, the ion conductive polymer 310 may include one of polyethylene glycol dimethyl ether, polyacrylonitrile, poly DOL, polyamide, polyacrylic acid, or polyphthalocyanine.

Referring to FIG. 3, the solvent 300 may be prepared by mixing the ion conductive polymer 310 and the deionized water 320.

A volume ratio of the ion conductive polymer 310 and the deionized water 320 in the solvent 300 may be greater than 1.5:1 and less than 9:1.

When the volume ratio of the ion conductive polymer 310 and the deionized water 320 is controlled to be greater than 1.5:1, the surface roughness of the composite coating layer 500 formed on the metal electrode 100 may be decreased.

In addition, when the volume ratio of the ion conductive polymer 310 and the deionized water 320 is controlled to be greater than 1.5:1 and less than 9:1, and the metal electrode 100 and the composite coating layer 500 formed on the metal electrode 100 are applied as a negative electrode of a secondary battery, an over potential of the secondary battery may be decreased.

In contrast, when the volume ratio of the ion conductive polymer 310 and the deionized water 320 is controlled to be less than or equal to 1.5:1 or greater than or equal to 9:1, and the metal electrode 100 and the composite coating layer 500 formed on the metal electrode 100 are applied as a negative electrode of a secondary battery, an over potential of the secondary battery may be increased.

Therefore, according to an embodiment of the present disclosure, in the preparing of the solvent 300, the volume ratio of the ion conductive polymer 310 and the deionized water 320 may be controlled to be greater than 1.5:1 and less than 9:1. Accordingly, the surface roughness of the composite coating layer 500 formed on the metal electrode 100 may be decreased, and when the metal electrode 100 and the composite coating layer 500 on the metal electrode 100 are applied as the negative electrode of the secondary battery, the over potential of the secondary battery may be decreased.

Referring to FIGS. 1 and 4, a composite coating layer source solution 400 may be prepared by mixing the POM 200 and the solvent 300 (S120).

The composite coating layer source solution 400 may be prepared by providing the POM 200 to the solvent 300 and mixing the POM 200 and the solvent 300 by using a stirrer.

In the preparing of the composite coating layer source solution 400, a weight of the POM 200 per a volume of the solvent 300 may be controlled to be greater than 300 g/L and less than 500 g/L.

When the weight of the POM 200 per the volume of the solvent 300 is controlled to be greater than 300 g/L and less than 500 g/L, the surface roughness of the composite coating layer 500 formed on the metal electrode 100 may be decreased.

In contrast, when the weight of the POM 200 per the volume of the solvent 300 is controlled to be less than or equal to 300 g/L, the surface roughness of the composite coating layer 500 formed on the metal electrode 100 may be increased.

Meanwhile, when the weight of the POM 200 per the volume of the solvent 300 is controlled to be greater than or equal to 500 g/L, the surface roughness of the composite coating layer 500 formed on the metal electrode 100 may be increased.

Therefore, according to the embodiment of the present disclosure, in the preparing of the composite coating layer source solution 400, the weight of the POM 200 per the volume of the solvent 300 may be controlled to be greater than 300 g/L and less than 500 g/L. Accordingly, the surface roughness of the composite coating layer 500 formed on the metal electrode 100 may be decreased.

Referring to FIGS. 1 and 5, the composite coating layer 500 may be prepared by providing and drying the composite coating layer source solution 400 on the metal electrode 100 (S130).

The preparing of the composite coating layer 500 on the metal electrode 100 may include: providing the composite coating layer source solution 400 on the metal electrode 100 and performing a heat treatment at a first temperature for a first time; and removing the composite coating layer source solution 400 that is unreacted on the metal electrode 100 and performing drying.

In the providing of the composite coating layer source solution 400 on the metal electrode 100 and the performing of the heat treatment at the first temperature for the first time, the POM 200 and the solvent 300 of the composite coating layer source solution 400 may react with each other to form the composite coating layer 500. For example, the first temperature may be 80° C. For example, the first time may be 6 hours.

In the removing of the composite coating layer source solution 400 that is unreacted on the metal electrode 100 and the performing of the drying, the unreacted composite coating layer source solution 400 may be removed from the metal electrode 100 by using the deionized water 320.

Therefore, the composite coating layer 500 may be formed on the metal electrode 100, so that a negative electrode 600 according to the embodiment of the present invention, which includes the metal electrode 100 and the composite coating layer 500, may be manufactured.

Accordingly, the composite coating layer 500 of the negative electrode 600 may include a polymer matrix 330 including the ion conductive polymer 310, and the POM 200 dispersed in the polymer matrix 330.

As described above, the central metal of the POM 200 may be one of molybdenum (Mo), tungsten (W), or vanadium (V).

When X-ray photoelectron spectroscopy (XPS) measurement for the POM 200 in the composite coating layer 500 is performed, a proportion of an ion of a central metal of the POM 200, which has a second oxidation number that is higher than a first oxidation number, may be higher than a proportion of an ion of the central metal of the POM 200, which has the first oxidation number. For example, the central metal of the POM 200 may be molybdenum (Mo). For example, the first oxidation number may be +5. For example, the second oxidation number may be +6. In other words, within the composite coating layer 500, a proportion of Mo⁶⁺ may be higher than a proportion of Mo⁵⁺.

According to the embodiment of the present invention, the method for manufacturing the negative electrode 600 may include preparing the solvent 300, and preparing the composite coating layer source solution 400.

As described above, according to the method in which the volume ratio of the ion conductive polymer 310 and the deionized water 320 is controlled to be greater than 1.5:1 and less than 9:1 in the preparing of the solvent 300, and the weight of the POM 200 per the volume of the solvent 300 is controlled to be greater than 300 g/L and less than 500 g/L in the preparing of the composite coating layer source solution 400, the surface roughness of the composite coating layer 500 formed on the metal electrode 100 may be decreased.

Therefore, when three-dimensional microscopy measurement for the surface roughness of the composite coating layer 500 of the negative electrode 600 is performed, an Sa value, which is an arithmetic mean height, corresponding to the surface roughness of the composite coating layer 500 may be less than or equal to 0.629 um.

Moreover, according to the method for manufacturing the negative electrode 600 of the embodiment of the present invention, a manufacturing process in which the composite coating layer 500 is formed on the metal electrode 100 may be simplified, so that a manufacturing time of the negative electrode 600 may be shortened. Accordingly, a manufacturing cost of the negative electrode 600 may be reduced, so that mass production of the negative electrode 600 may be facilitated.

In addition, as described above, regarding the composite coating layer 500 of the negative electrode 600, during the charging/discharging process, the side reaction may be suppressed by the POM 200 of the composite coating layer 500, so that the side reactant on the metal electrode 100 may be minimized.

In addition, regarding the composite coating layer 500 of the negative electrode 600, the POM 200 and the polymer matrix 330 including the ion conductive polymer 310 may reduce a transfer resistance of the metal ion. Accordingly, during the charging/discharging process, plating and stripping of the metal ion on the metal electrode 100 of the negative electrode 600 may be facilitated. Therefore, the negative electrode 600 including the metal electrode 100 and the composite coating layer 500 formed on the metal electrode 100 may be applied to a secondary battery.

The secondary battery may include the negative electrode 600, a positive electrode formed on the negative electrode 600, and an electrolyte formed between the negative electrode 600 and the positive electrode.

Referring to FIG. 6, a structure of the negative electrode 600 of the secondary battery after charging/discharging the secondary battery a reference number of times or more is described.

Before charging/discharging the secondary battery, as described above, the negative electrode 600 may include the metal electrode 100 and the composite coating layer 500 formed on the metal electrode 100. In addition, the composite coating layer 500 may include the polymer matrix 330 and the POM 200 dispersed in the polymer matrix 330.

In the process of charging/discharging the secondary battery the reference number of times or more, the side reaction may be suppressed by the POM 200 of the composite coating layer 500, so that the side reactant on the metal electrode 100 may be minimized. Therefore, electrical characteristics of the secondary battery may be improved. In addition, regarding the composite coating layer 500, the POM 200 and the polymer matrix 330 including the ion conductive polymer 310 may reduce the transfer resistance of the metal ion. Therefore, the plating and the stripping of the metal ion on the metal electrode 100 of the negative electrode 600 may be facilitated. Accordingly, growth of dendrite on the metal electrode 100 may be suppressed, so that a metallization layer 110 obtained by the plating of the metal ion may be substantially uniformly formed on the metal electrode 100, and a passivation layer 510 may be substantially uniformly on the metallization layer 110. Therefore, long-term stability of the secondary battery over charging/discharging cycles may be improved.

Therefore, after charging/discharging the secondary battery the reference number of times or more, the negative electrode 600 may include the metal electrode 100, the metallization layer 110 formed on the metal electrode 100, and the passivation layer 510 formed on the metallization layer 110. In addition, the metallization layer 110 and the passivation layer 510 may include the POM 200 and the polymer matrix 330 of the composite coating layer 500. Meanwhile, the POM 200 and the polymer matrix 330 of the composite coating layer 500 may not be observed due to the metallization layer 110 and the passivation layer 510.

Hereinafter, specific experimental examples and characteristic evaluation results of the negative electrode according to the embodiment of the present invention will be described.

### Manufacture of Negative Electrode According to Experimental Example 1 (PPZn)

A zinc thin film (4 cm×11 cm) was prepared as a metal electrode, H₃PMo₁₂O₄₀ (phosphomolybdic acid) was prepared as polyoxometalate (POM)), polyethylene glycol dimethyl ether (PEGDME) (ion conductive polymer) and deionized water (DIW) were prepared as a solvent, and an OHP film (3 cm×10 cm, 100 um) including a hole was prepared as a guide film.

The POM (200 mg) and the solvent (the ion conductive polymer (400 uL) and the deionized water (100 uL)) were mixed with each other to prepare a composite coating layer source solution.

In addition, the guide film was attached to the metal electrode, the composite coating layer source solution was provided to the hole of the guide film, and the metal electrode was coated with the composite coating layer source solution by using a doctor blade.

Thereafter, the metal electrode coated with the composite coating layer source solution was dried at 80° C. for 6 hours, unreacted POM was removed by using the deionized water, and drying was performed, so that a composite coating layer was formed on the metal electrode, thereby manufacturing a negative electrode.

### Manufacture of Negative Electrode According to Experimental Example 2 (POMZn)

A negative electrode according to Experimental Example 2 was manufactured in the same manner as Experimental Example 1, except that only the deionized water (500 uL) was used as the solvent without the ion conductive polymer.

### Negative Electrode According to Comparative Example (Bare Zn)

A zinc thin film that is the same as the zinc thin film used as the metal electrode in Experimental Example 1 was used as a negative electrode.

TABLE 1

| | POM | PEGDME | DIW |
|---|---|---|---|
| Classification | (mg) | (uL) | (uL) |
| Experimental Example 1 (PPZn) | 200 | 400 | 100 |
| Experimental Example 2 (POMZn) | 200 | — | 500 |
| Comparative Example (Bare Zn) | — | — | — |

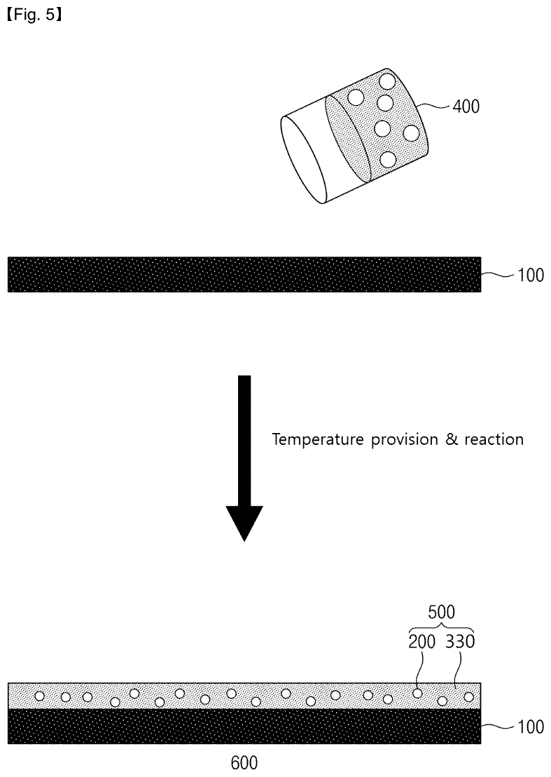

FIG. 7A is a photograph of a surface of a negative electrode according to Experimental Example 2 of the present invention, and FIG. 7B is a photograph of a surface of a negative electrode according to Experimental Example 1 of the present invention.

Referring to FIGS. 7A and 7B, processes of manufacturing negative electrodes according to Experimental Example 2 and Experimental Example 1 were photographed. The left photograph is a photograph after the metal electrode is coated with the composite coating layer source solution, the middle photograph is a photograph after the composite coating layer source solution with which the metal electrode is coated is reacted at 80° C. for 6 hours, and the right photograph is a photograph after unreacted POM of the composite coating layer source solution with which the metal electrode is coated is washed and removed with the deionized water.

As shown in FIGS. 7A and 7B, the composite coating layer according to Experimental Example 1 was formed on the metal electrode more uniformly than the composite coating layer according to Experimental Example 2.

This is because the ion conductive polymer of the composite coating layer source solution according to Experimental Example 1 lowered a reaction rate of the POM.

Therefore, in the process of providing a temperature to the composite coating layer source solution to react the POM and the ion conductive polymer, the ion conductive polymer lowered the reaction rate of the POM, so that the composite coating layer that is substantially uniform was formed on the metal electrode.

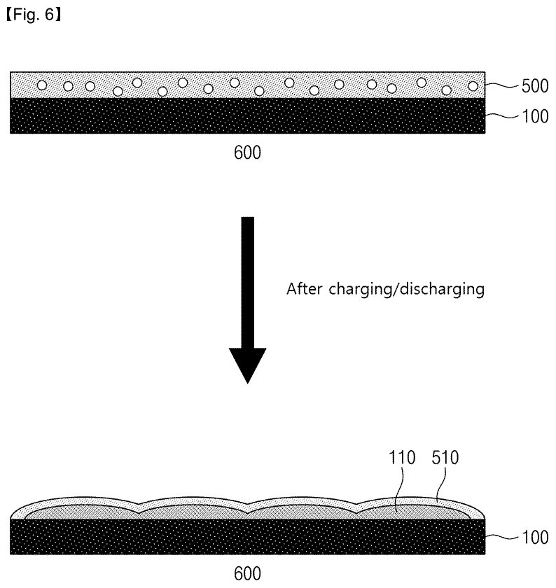

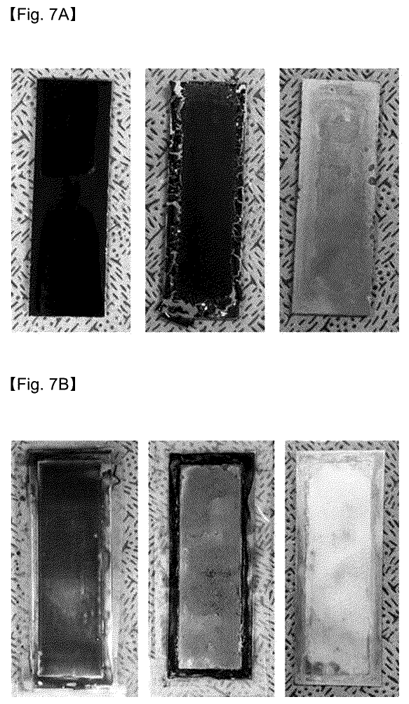

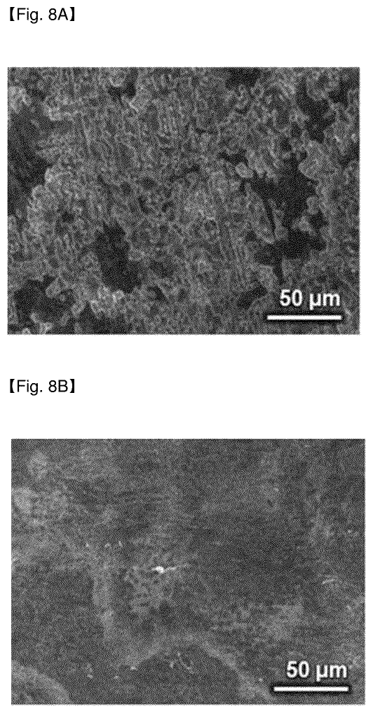

FIG. 8A is an SEM photograph of the negative electrode according to Experimental Example 2 of the present invention, and FIG. 8B is an SEM photograph of the negative electrode according to Experimental Example 1 of the present invention.

Referring to FIGS. 8A and 8B, surfaces of the negative electrodes according to Experimental Example 2 and Experimental Example 1 were photographed by using an SEM.

As shown in FIGS. 8A and 8B, surface roughness of the composite coating layer of the negative electrode according to Experimental Example 1 was lower than surface roughness of the composite coating layer of the negative electrode according to Experimental Example 2.

This is because, during the process of preparing the composite coating layer according to Experimental Example 1, the ion conductive polymer of the composite coating layer source solution alleviated a strongly acidic characteristic of the POM and lowered the reaction rate.

Therefore, during the process of preparing the composite coating layer, the ion conductive polymer alleviated the strongly acidic characteristic of the POM and lowered the reaction rate of the POM, so that the composite coating layer that is substantially uniform was formed on the metal electrode.

FIG. 9A is a photograph for analyzing surface roughness of the surface of the negative electrode according to Experimental Example 2 of the present invention by using a three-dimensional measurement device, and FIG. 9B is a photograph for analyzing surface roughness of the surface of the negative electrode according to Experimental Example 1 of the present invention by using the three-dimensional measurement device.

Referring to FIGS. 9A and 9B, the surfaces of the negative electrodes according to Experimental Example 2 and Experimental Example 1 were measured by using a three-dimensional measurement device to measure arithmetic mean heights (Sa) of the composite coating layers of the negative electrodes according to Experimental Example 2 and Experimental Example 1.

As shown in FIGS. 9A and 9B, an Sa value (0.629 um) of the composite coating layer of the negative electrode according to Experimental Example 1 was lower than an Sa value (0.826 um) of the composite coating layer of the negative electrode according to Experimental Example 2 by 23.85%. Therefore, the metal electrode was more uniformly coated with the composite coating layer according to Experimental Example 1 than the composite coating layer according to Experimental Example 2.

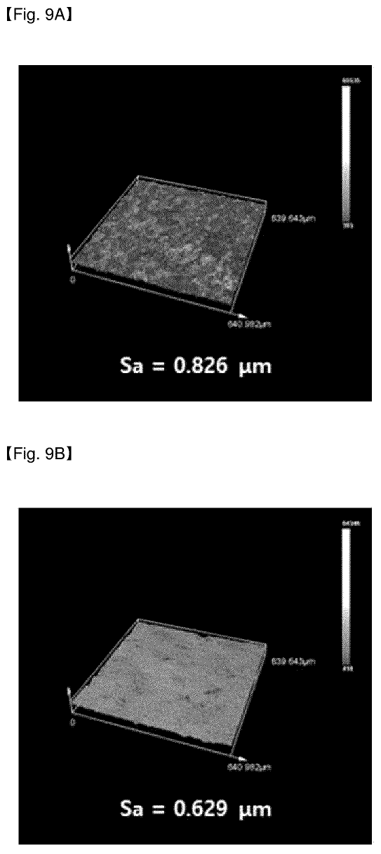

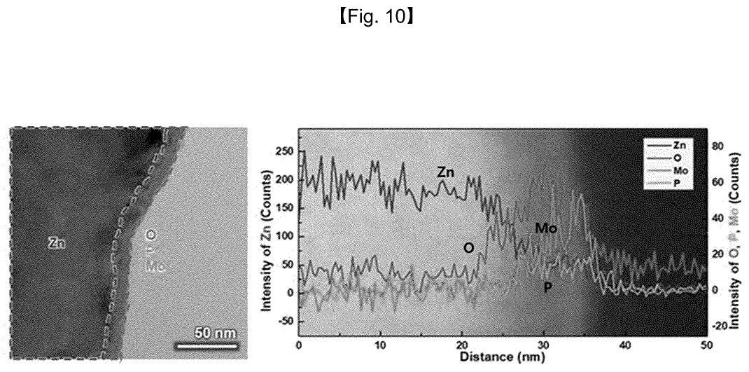

FIG. 10 shows a result of analyzing the negative electrode according to Experimental Example 1 of the present invention through high resolution transmission electron microscopy (HRTEM).

Referring to FIG. 10, the negative electrode according to Experimental Example 1 was cross-cut with a focused ion beam (FIB), a thickness of the composite coating layer of the negative electrode was photographed by using high resolution transmission electron microscopy (HRTEM), and chemical elements of the composite coating layer were analyzed.

As shown in FIG. 10, the thickness of the composite coating layer was 10 to 15 nm. In addition, P, Mo, and O were detected as the chemical elements of the composite coating layer. Therefore, the POM (PMo₁₂O₄₀) existed in the composite coating layer.

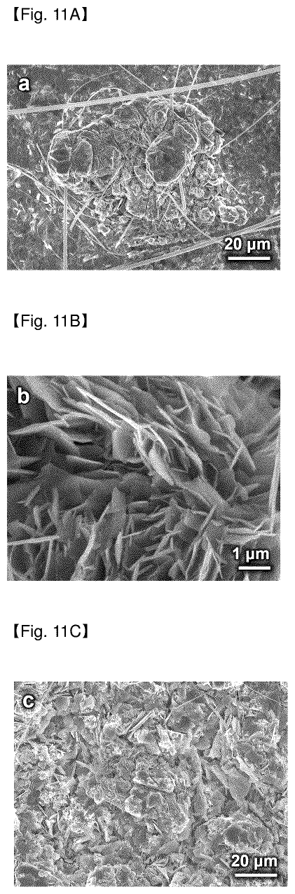

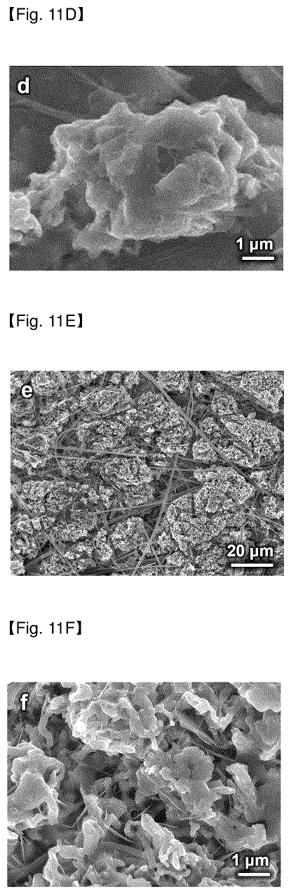

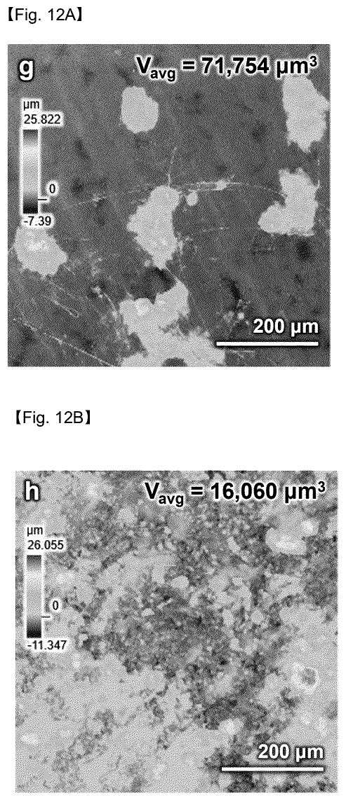

FIGS. 11A and 11B are SEM photographs of a negative electrode according to Comparative Example of the present invention after manufacturing a symmetric cell with the negative electrode and performing charging/discharging cycles, FIGS. 11C and 11D are SEM photographs of a negative electrode according to Experimental Example 2 of the present invention after manufacturing a symmetric cell with the negative electrode and performing charging/discharging cycles, FIGS. 11E and 11F are SEM photographs of a negative electrode according to Experimental Example 1 of the present invention after manufacturing a symmetric cell with the negative electrode and performing charging/discharging cycles, FIG. 12A is a 3D laser scanning microscope (3DLSM) photograph of the negative electrode according to Comparative Example of the present invention after manufacturing the symmetric cell with the negative electrode and performing the charging/discharging cycles, FIG. 12B is a 3DLSM photograph of the negative electrode according to Experimental Example 1 of the present invention after manufacturing the symmetric cell with the negative electrode and performing the charging/discharging cycles, and FIG. 13 is an XRD graph for comparing side reactants generated in the negative electrodes according to Comparative Example and Experimental Examples of the present invention after manufacturing the symmetric cells with the negative electrodes and performing the charging/discharging cycles.

Referring to FIGS. 11A to 11F, symmetric cells were manufactured with the negative electrodes according to Comparative Example, Experimental Example 1, and Experimental Example 2. In addition, after 10 charging/discharging cycles are performed on the symmetric cells according to Comparative Example, Experimental Example 1, and Experimental Example 2 through chronopotentiometry (CP) (with a current density (4 mAcm⁻²) and a charge amount (1 mAh)), the surfaces of the negative electrodes of the symmetric cells according to Comparative Example, Experimental Example 1, and Experimental Example 2 were photographed by using the SEM. Referring to FIGS. 12A and 12B, after 10 charging/discharging cycles are performed on the symmetric cells according to Comparative Example and Experimental Example 1 in FIGS. 11A to 11F under the same conditions as FIGS. 11A to 11F, the surfaces of the negative electrodes of the symmetric cells according to Comparative Example and Experimental Example 1 were photographed by using a 3D laser scanning microscope (3DLSM). Referring to FIG. 13, after 10 charging/discharging cycles are performed on the symmetric cells according to Comparative Example, Experimental Example 1, and Experimental Example 2 in FIGS. 11A to 11F under the same conditions as in FIGS. 11A to 11F, the negative electrodes of the symmetric cells according to Comparative Example, Experimental Example 1, and Experimental Example 2 were analyzed by using XRD. In addition, peaks of side reactants ((Zn(OH)₂)₃(ZnSO₄)(H₂O)₅) generated on the negative electrodes of the symmetric cells according to Comparative Example, Experimental Example 1, and Experimental Example 2 were compared with each other.

As shown in FIGS. 11A to 11F, the smallest amount of dendrite was generated on the negative electrode of the symmetric cell according to Experimental Example 1.

As shown in FIGS. 12A and 12B, a size of dendrite generated on the negative electrode of the symmetric cell according to Experimental Example 1 was smaller than a size of dendrite generated on the negative electrode of the symmetric cell according to Comparative Example.

This is because the composite coating layer on the metal electrode of the negative electrode of the symmetric cell according to Experimental Example 1 suppressed growth of the dendrite while the charging/discharging cycles are performed.

As shown in FIG. 13, each of the side reactants generated on the negative electrodes of the symmetric cells according to Experimental Example 1 and Experimental Example 2 was less than the side reactant generated on the negative electrode of the symmetric cell according to Comparative Example.

This is due to the POMs of the negative electrodes of the symmetric cells according to Experimental Example 1 and Experimental Example 2. Therefore, the POMs suppressed the side reactions.

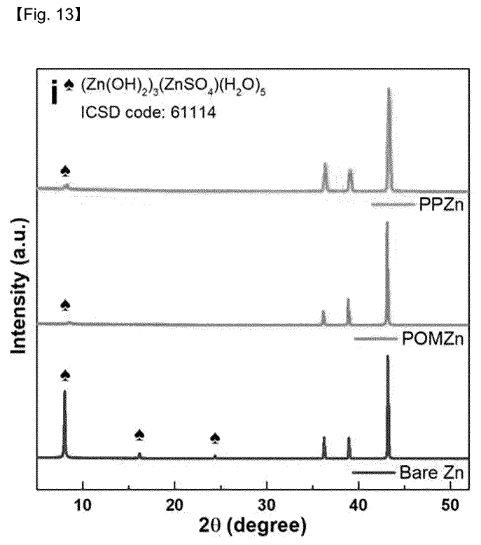

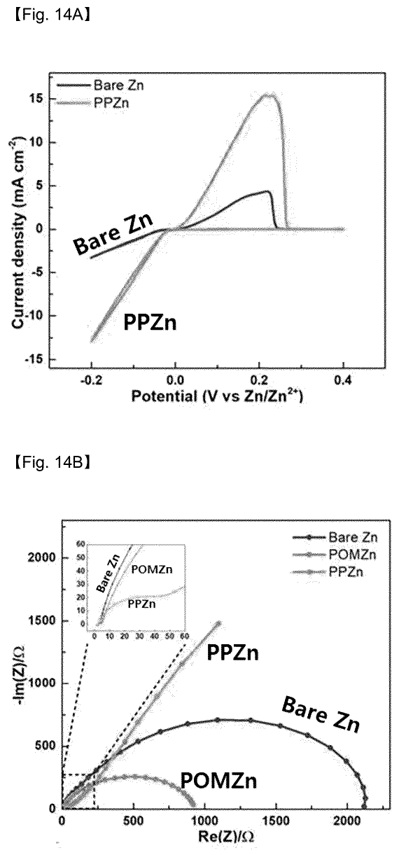

FIG. 14A is a graph obtained by manufacturing Zn∥Cu cells with the negative electrodes according to Comparative Example and Experimental Example 1 of the present invention and performing measurement through cyclic voltammetry (CV), FIG. 14B is a graph obtained by manufacturing Zn∥Cu cells with the negative electrodes according to Comparative Example and Experimental Examples of the present invention and performing analysis through electrochemical impedance spectroscopy (EIS), and FIG. 14C is a graph obtained by manufacturing the Zn∥Cu cells with the negative electrodes according to Comparative Example and Experimental Example 1 of the present invention and showing a Tafel plot.

Referring to FIG. 14A, Zn∥Cu cells according to Comparative Example and Experimental Example 1 were manufactured by using the negative electrodes according to Comparative Example and Experimental Example 1 and a positive electrode (Cu), and CV measurement was performed. Referring to FIG. 14B, Zn∥Cu cells according to Comparative Example, Experimental Example 1, and Experimental Example 2 were manufactured by using the negative electrodes according to Comparative Example, Experimental Example 1, and Experimental Example 2 in the same manner as FIG. 14A, and electrochemical impedance spectroscopy (EIS) analysis was performed. Referring to FIG. 14C, Tafel plots of the Zn∥Cu cells according to Comparative Example and Experimental Example 1 were shown as graphs with reference to measured CV data of the Zn∥Cu cells according to Comparative Example and Experimental Example 1 in FIG. 14A.

As shown in FIGS. 14A to 14C, a maximum value of a current density of the Zn∥Cu cell according to Comparative Example was 4.36 mAcm⁻², and a maximum value of a current density of the Zn∥Cu cell according to Experimental Example 1 was 15.41 mAcm⁻². In addition, an onset potential value of the Zn∥Cu cell according to Comparative Example was −0.036 V, and an onset potential value of the Zn∥Cu cell according to Experimental Example 1 was −0.018 V.

Therefore, the maximum value of the current density of the Zn∥Cu cell according to Experimental Example 1 was about 3.5 times higher than the maximum value of the current density of the Zn∥Cu cell according to Comparative Example. In addition, the onset potential value of the Zn∥Cu cell according to Experimental Example 1 was about 2 times lower than the onset potential value of the Zn∥Cu cell according to Comparative Example. Moreover, an exchange current density of the Zn∥Cu cell according to Experimental Example 1 was about 3.7 times higher than an exchange current density of the Zn∥Cu cell according to Experimental Example 2.

In addition, a series resistance of the Zn∥Cu cell according to Comparative Example was 4.78Ω, a series resistance of the Zn∥Cu cell according to Experimental Example 2 was 4.42Ω, and a series resistance of the Zn∥Cu cell according to Experimental Example 1 was 2.82Ω, so that the series resistance of the Zn∥Cu cell according to Experimental Example 1 was the lowest.

In addition, a charge transfer resistance of the Zn∥Cu cell according to Comparative Example was 1811Ω, a charge transfer resistance of the Zn∥Cu cell according to Experimental Example 2 was 935.4Ω, and a charge transfer resistance of the Zn∥Cu cell according to Experimental Example 1 was 41.62Ω, so that the charge transfer resistance of the Zn∥Cu cell according to Experimental Example 1 was the lowest.

As a result, plating and stripping of Zn ions on the surface of the negative electrode were easier in the negative electrode of the Zn∥Cu cell according to Experimental Example 1 than in the negative electrode of the Zn∥Cu cell according to Comparative Example.

This is due to the composite coating layer on the metal electrode of the negative electrode of the Zn∥Cu cell according to Experimental Example 1.

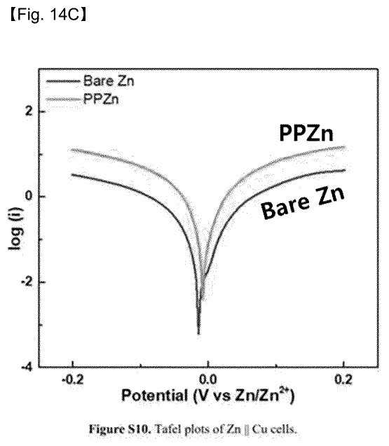

FIGS. 15A and 15B are graphs for comparing long-term stability of the symmetric cells according to Comparative Example and Experimental Example 1 by manufacturing the symmetric cells with the negative electrodes according to Comparative Example and Experimental Example 1 of the present invention.

Referring to FIG. 15A, symmetric cells were manufactured with the negative electrodes according to Comparative Example and Experimental Example 1. In addition, chronopotentiometry (CP) measurement was performed on the symmetric cells according to Comparative Example and Experimental Example 1 for a long time under conditions of a current density (4 mAcm⁻²) and a charge amount (1 mAh). Referring to FIG. 15B, CP measurement was performed on the symmetric cells of the negative electrodes according to Comparative Example and Experimental Example 1 in FIG. 15A for a long time under conditions of a current density (10 mAcm⁻²) and a charge amount (1 mAh).

As shown in FIG. 15A, a lifespan of the symmetric cell according to Experimental Example 1 was about 225 times longer than a lifespan of the symmetric cell according to Comparative Example. As shown in of FIG. 15A, the lifespan of the symmetric cell according to Experimental Example 1 was about 90 times longer than the lifespan of the symmetric cell according to Comparative Example.

Therefore, long-term stability was excellent in the symmetric cell according to Experimental Example 1 as compared with the symmetric cell according to Comparative Example.

This is due to the composite coating layer on the metal electrode of the negative electrode of the symmetric cell according to Experimental Example 1.

FIG. 16 is a graph showing a cumulative capacity according to a current density to compare the symmetric cell manufactured with the negative electrode having a composite coating layer according to Experimental Example 1 of the present invention and symmetric cells manufactured with negative electrodes having coating layers according to Experimental Modification Examples.

Referring to FIG. 16, a symmetric cell was manufactured with the negative electrode having the composite coating layer according to Experimental Example 1. In addition, symmetric cells were manufactured with negative electrodes having BTO, Silane, Ni₅Zn₂₁, ZnF₂—CuZn, AgZn₃, BTC, CuₓZn_{y}, CaCo₃, SiO₂, Alucone, and PAN coating layers according to Experimental Modification Examples. Thereafter, chronopotentiometry (CP) measurement was performed on the symmetric cells according to Experimental Example 1 and Experimental Modification Examples, and a cumulative capacity according to a current density was shown in a graph.

As shown in FIG. 16, a cumulative capacity of the symmetric cell according to Experimental Example 1 was the highest overall.

Therefore, an overvoltage potential of the symmetric cell according to Experimental Example 1 was the lowest, and the symmetric cell according to Experimental Example 1 had long-term stability over charging/discharging cycles.

This is due to the composite coating layer on the metal electrode of the negative electrode of the symmetric cell according to Experimental Example 1.

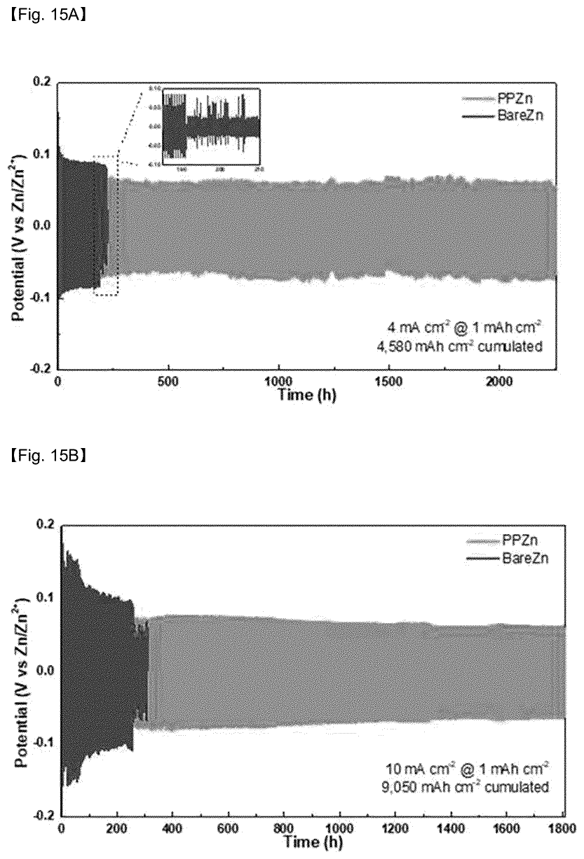

FIG. 17A is a graph obtained by manufacturing a full cell with the negative electrode according to Comparative Example of the present invention and performing measurement through cyclic voltammetry (CV) for each scan rate, and FIG. 17B is a graph obtained by manufacturing a full cell with the negative electrode according to Experimental Example 1 of the present invention and performing measurement through CV for each scan rate.

Referring to FIGS. 17A and 17B, full cells were manufactured with the negative electrodes according to Comparative Example and Experimental Example 1 and a positive electrode (β-MnO₂). In addition, CV measurement was performed on the full cells according to Comparative Example and Experimental Example 1 for each scan rate (0.1 mV/s, 0.2 mV/s, 0.3 mV/s, 0.4 mV/s, and 0.5 mV/s).

As shown in FIGS. 17A and 17B, a voltage difference between charging and discharging stages was lower in the full cell according to Experimental Example 1 than in the full cell according to Comparative Example. Therefore, the full cell according to Experimental Example 1 had a lower over potential than the full cell according to Comparative Example.

This is due to the composite coating layer on the metal electrode of the negative electrode of the full cell according to Experimental Example 1.

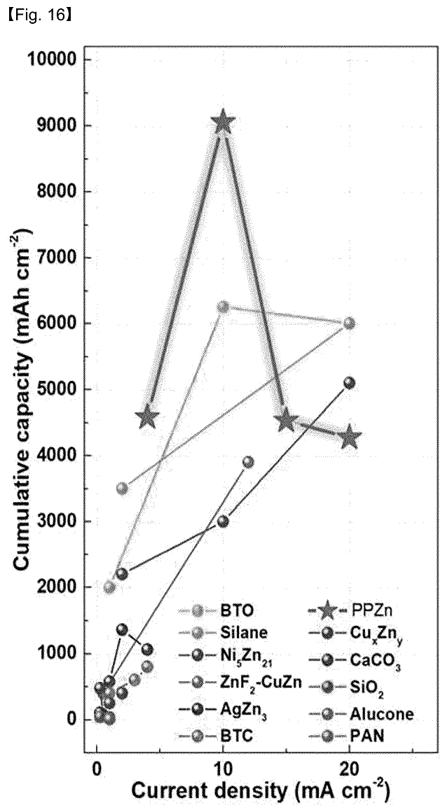

FIG. 18 is a graph obtained by manufacturing the full cells with the negative electrodes according to Comparative Example and Experimental Example 1 of the present invention and performing analysis through electrochemical impedance spectroscopy (EIS).

Referring to FIG. 18, full cells were manufactured with the negative electrodes according to Comparative Example and Experimental Example 1 and a positive electrode (β-MnO₂). In addition, the full cells according to Comparative Example and Experimental Example 1 were analyzed through electrochemical impedance spectroscopy (EIS).

As shown in FIG. 18, each of series resistances of the full cells according to Comparative Example and Experimental Example 1 was measured to be about 2Ω. Meanwhile, only in the full cell according to Experimental Example 1, a semicircle having a diameter of about 4Ω existed in a high-frequency region.

This is because a charge transfer resistance was reduced by the POM of the composite coating layer of the negative electrode of the full cell according to Experimental Example 1.

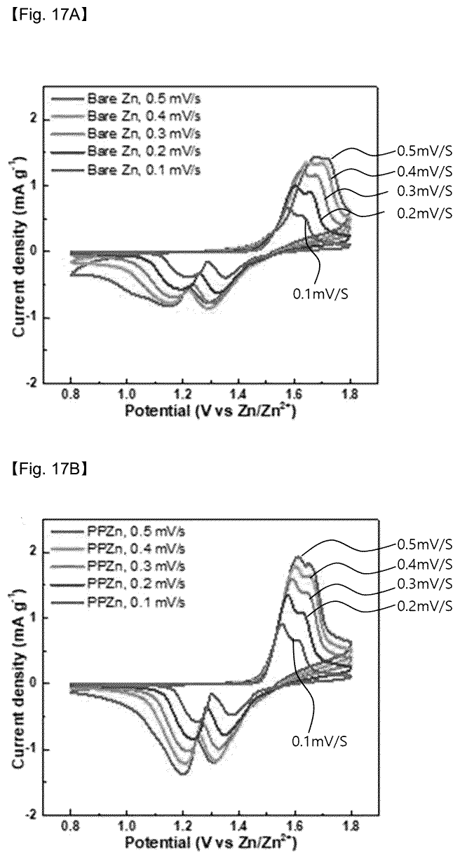

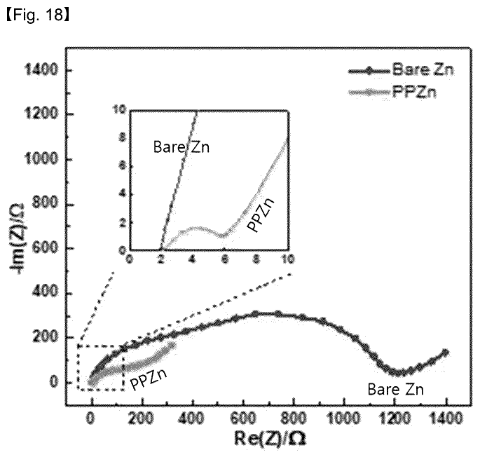

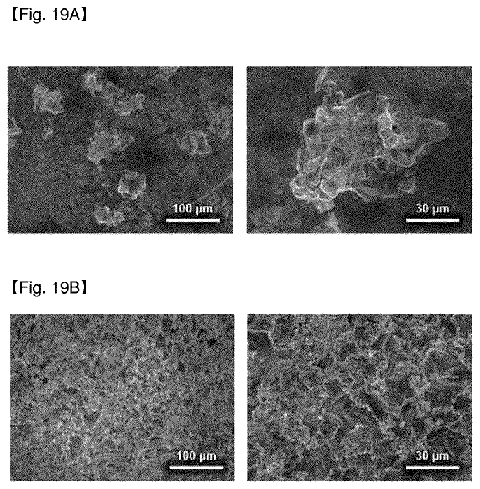

FIG. 19A is an SEM photograph of the negative electrode of the full cell according to Comparative Example of the present invention after manufacturing the full cell with the negative electrode according to Comparative Example of the present invention and performing charging/discharging cycles, and FIG. 19B is an SEM photograph of the negative electrode of the full cell according to Experimental Example 1 of the present invention after manufacturing the full cell with the negative electrode according to Experimental Example 1 of the present invention and performing charging/discharging cycles.

Referring to FIGS. 19A and 19B, full cells were manufactured with the negative electrodes according to Comparative Example and Experimental Example 1 and a positive electrode (β-MnO₂). In addition, after 50 charging/discharging cycles are performed on the full cells according to Comparative Example and Experimental Example 1 at a current density of 3 C, the negative electrodes of the full cells according to Comparative Example and Experimental Example 1 were photographed by using the SEM.

As shown in FIGS. 19A and 19B, dendrite generated on the negative electrode of the full cell according to Experimental Example 1 had a smaller size than dendrite generated on the negative electrode of the full cell according to Comparative Example.

In addition, during the charging/discharging cycles of the full cell according to Experimental Example 1, plating and stripping of Zn ions on the metal electrode of the negative electrode were facilitated by the composite coating layer of the negative electrode of the full cell according to Experimental Example 1, so that a metallization layer and a passivation layer, which are substantially uniform, were formed.

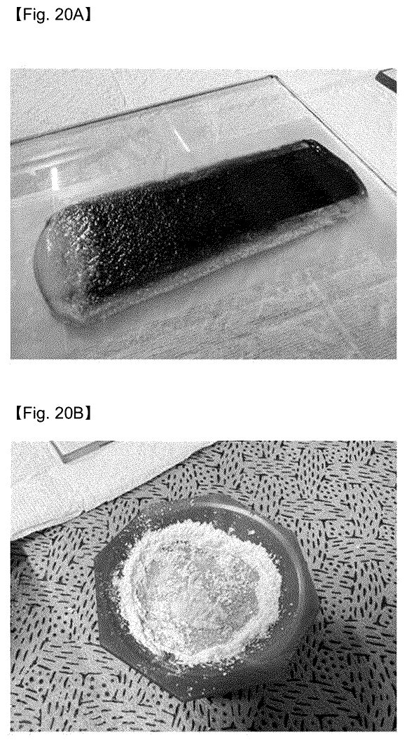

FIG. 20A is a photograph of a composite coating layer on a metal electrode of a negative electrode according to Experimental Modification Example of the present invention, and FIG. 20B is a photograph of a composite coating layer source solution according to Experimental Modification Example of the present invention.

Referring to FIG. 20A, in order to prepare a composite coating layer according to Experimental Modification Example, a composite coating layer source solution was prepared in the same manner as Experimental Example 1, except that polyacrylonitrile (PAN) was used instead of polyethylene glycol dimethyl ether (PEDGME) as the ion conductive polymer of the solvent. In addition, after the composite coating layer source solution is provided on the metal electrode, the composite coating layer on the metal electrode was photographed. Referring to FIG. 20B, a photograph in which polyoxometalate (POM) and polyvinylidene fluoride (PVDF), which is an ion conductive polymer, are provided in deionized water so as to be mixed is shown.

As shown in FIGS. 20A and 20B, after the composite coating layer source solution including the PAN is provided on the metal electrode, a color of the composite coating layer changed to blue. Accordingly, the PAN did not act to lower the reaction rate of the POM like the PEGDME.

Meanwhile, it was difficult for the PVDF to be dissolved in the deionized water, so that it was difficult to prepare the composite coating layer source solution with the PVDF.

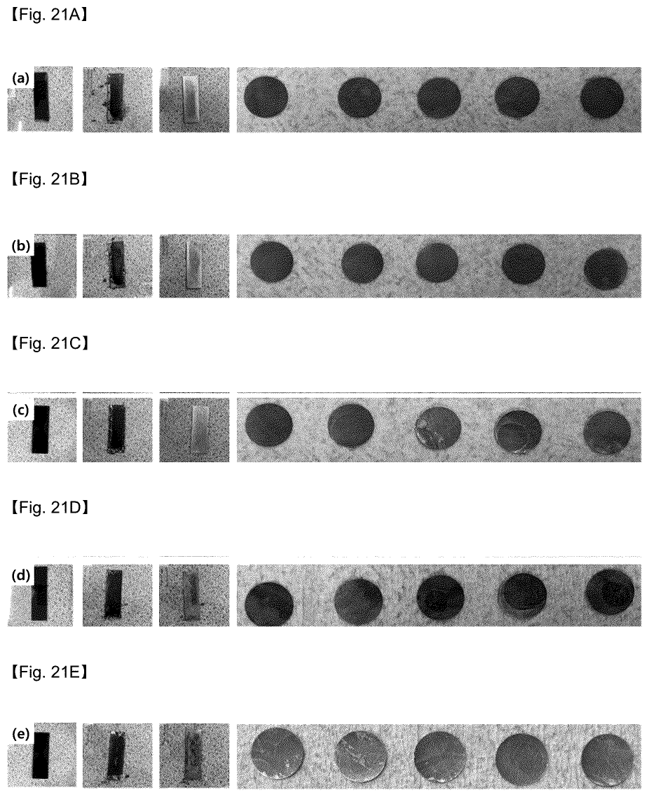

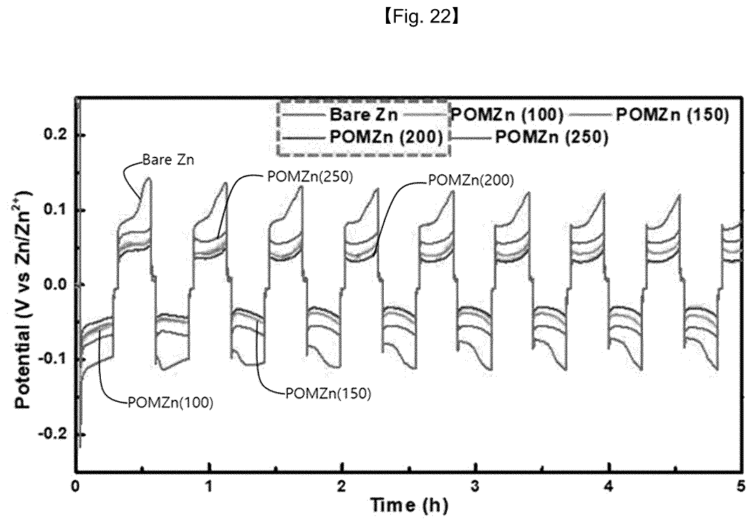

FIGS. 21A to 21E is a photograph obtained by capturing processes of manufacturing negative electrodes and the manufactured negative electrodes according to Experimental Example 2 and Experimental Modification Examples of the present invention, and FIG. 22 is a graph obtained by manufacturing symmetric cells with the negative electrodes according to Comparative Example, Experimental Example 2, and Experimental Modification Examples of the present invention and performing measurement through chronopotentiometry (CP).

Referring to FIGS. 21A to 21C, 21D, and 21E, as shown in Table 2 below, processes of manufacturing negative electrodes in the same manner as Experimental Example 1 by using composite coating layer source solutions prepared by providing different amounts of POM to DIW and the manufactured negative electrode according to Experimental Modification Examples were photographed. Referring to FIG. 21C, a process of manufacturing a negative electrode and the manufactured negative electrode according to Experimental Example 2 were photographed. Referring to FIG. 22, as shown in Table 2 below, symmetric cells were manufactured with negative electrodes according to Comparative Example, Experimental Example 2, and Experimental Modification Examples. In addition, CP measurement was performed on the symmetric cells according to Comparative Example, Experimental Example 2, and Experimental Modification Examples under conditions of a current density (4 mAcm⁻²) and a charge amount (1 mAh).

As shown in FIGS. 21A to 21E, the composite coating layer on the metal electrode of the negative electrode according to Experimental Example 2 was formed most uniformly.

As shown in FIG. 22, the symmetric cell according to Experimental Example 2 had the lowest over potential value.

Therefore, a method that controls an amount of the POM of the composite coating layer source solution to be greater than 300 g/L and less than 500 g/L was a method that decreases surface roughness of the composite coating layer and decreases an over potential of the symmetric cell to which the negative electrode including the composite coating layer is applied.

TABLE 2

| | | | FIGS. 21A | |
|---|---|---|---|---|
| | | | to 21E | FIG. 22 |
| | POM | DIW | (Negative | (Symmetric |
| Classification | (mg) | (uL) | Electrode) | Cell) |
| Comparative Example | — | — | — | Bare Zn |
| Experimental Example 2 | 200 | 500 | FIG. 21C | POMZn (200) |
| Experimental | 100 | 500 | FIG. 21A | POMZn (100) |
| Modification Example 1 | | | | |
| Experimental | 150 | 500 | FIG. 21B | POMZn (150) |
| Modification Example 2 | | | | |
| Experimental | 250 | 500 | FIG. 21D | POMZn (250) |
| Modification Example 3 | | | | |
| Experimental | 300 | 500 | FIG. 21E | — |
| Modification Example 4 | | | | |

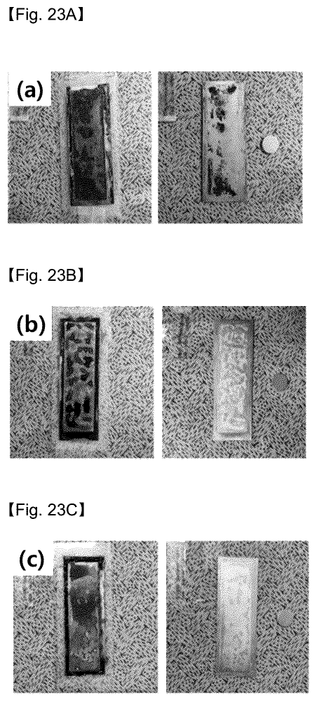

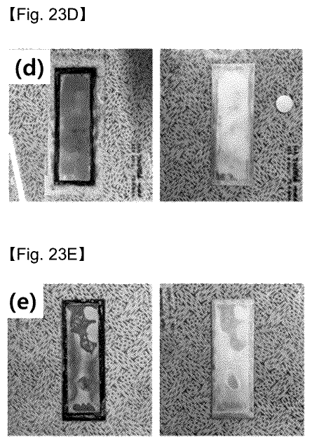

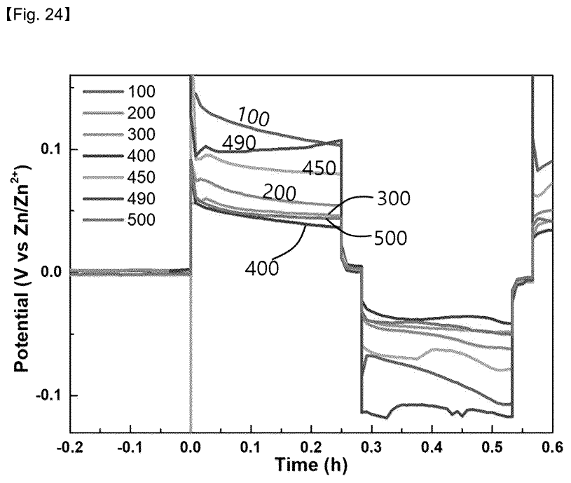

FIGS. 23A to 23C and 23E are photographs of the processes of manufacturing the negative electrodes and the manufactured negative electrodes according to Experimental Modification Examples of the present invention, FIG. 23D is a photograph of a process of manufacturing a negative electrode and the manufactured negative electrode according to Experimental Example 1 of the present invention, and FIG. 24 is a graph obtained by manufacturing symmetric cells with the negative electrodes according to Experimental Example 1 and Experimental Modification Examples of the present invention and performing measurement through chronopotentiometry (CP).

Referring to FIGS. 23A to 23C and 23E, as shown in Table 3 below, volumes of PEGDME and DIW were controlled to prepare composite source solutions according to Experimental Modification Examples. In addition, each of the complex source solutions according to Experimental Modification Examples was provided on the metal electrode, dried, and photographed, and negative electrodes according to Experimental Modification Examples manufactured by removing unreacted POMs of the composite source solutions according to Experimental Modification Examples by using the DIW were photographed. Referring to FIG. 23D, the composite source solution according to Experimental Example 1 was provided on the metal electrode, dried, and photographed, and the negative electrode according to Experimental Example 1 manufactured by removing unreacted POM by using the DIW was photographed. Referring to FIG. 24, as shown in Table 3 below, symmetric cells were manufactured with the negative electrodes according to Experimental Example 1 and Experimental Modification Examples in FIGS. 23A to 23E. In addition, CP measurement was performed on the symmetric cells according to Experimental Example 1 and Experimental Modification Examples under conditions of a current density (4 mAcm⁻²) and a charge amount (1 mAh).

As shown in FIGS. 23A to 23E, coating of the composite coating layer on the metal electrode of the negative electrode according to Experimental Example 1 was performed most uniformly. Therefore, when the volume ratio of the ion conductive polymer (PEDGME) and the deionized water (DIW) is greater than 1.5:1, the surface roughness of the composite coating layer on the metal electrode was decreased. In addition, in order to decrease the surface roughness of the composite coating layer on the metal electrode, the deionized water had to be necessarily included in the composite source solution.

As shown in FIG. 24, the symmetric cell according to Experimental Example 1 had the lowest over potential value. In addition, when the volume ratio of the ion conductive polymer and the deionized water is controlled to be greater than 1.5:1 and less than 9:1, the over potential value was decreased.

In conclusion, a method that controls the volume ratio of the ion conductive polymer and the deionized water of the composite source solution to be greater than 1.5:1 and less than 9:1 was a method that decreases the surface roughness of the composite coating layer and decreases the over potential of the symmetric cell to which the negative electrode including the composite coating layer is applied.

TABLE 3

| | | | | FIGS. 23A | |
|---|---|---|---|---|---|
| | | | | to 23E | FIG. 24 |
| | POM | PEGDME | DIW | (Negative | (Symmetric |
| Classification | (mg) | (uL) | (uL) | Electrode) | Cell) |
| Experimental | 200 | 400 | 100 | FIG. 23D | 400 |
| Example 1 | | | | | |
| Experimental | 200 | 100 | 400 | FIG. 23A | 100 |
| Modification | | | | | |
| Example 5 | | | | | |
| Experimental | 200 | 200 | 300 | FIG. 23B | 200 |
| Modification | | | | | |
| Example 6 | | | | | |
| Experimental | 200 | 300 | 200 | FIG. 23C | 300 |
| Modification | | | | | |
| Example 7 | | | | | |
| Experimental | 200 | 500 | — | FIG. 23E | 500 |
| Modification | | | | | |
| Example 8 | | | | | |
| Experimental | 200 | 450 | 50 | — | 450 |
| Modification | | | | | |
| Example 9 | | | | | |
| Experimental | 200 | 490 | 10 | — | 490 |
| Modification | | | | | |
| Example 10 | | | | | |

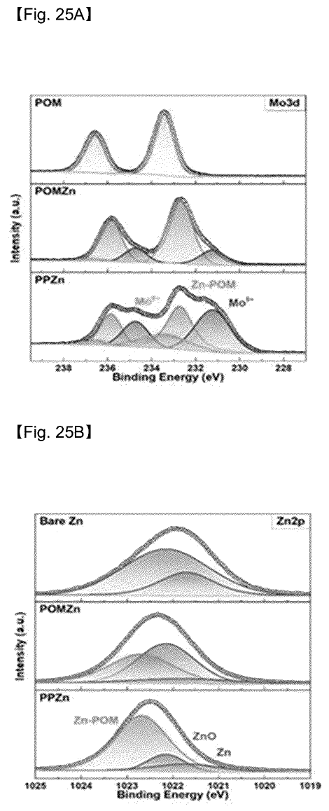

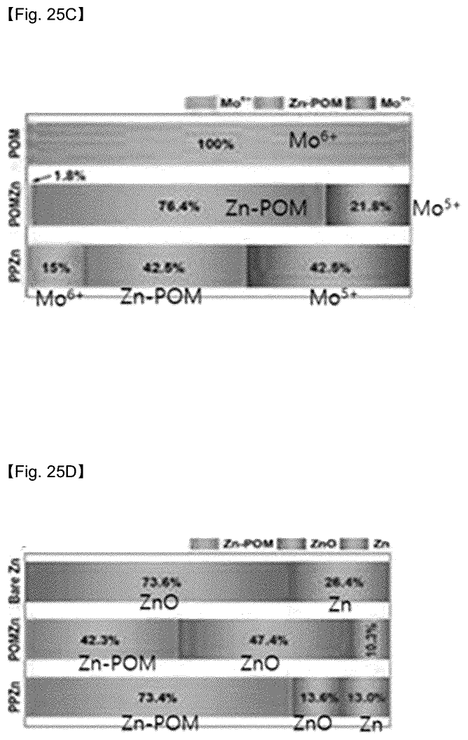

FIGS. 25A to 25D are graphs for analyzing the negative electrodes according to Comparative Example and Experimental Examples of the present invention through X-ray photoelectron spectroscopy (XPS).

Referring to FIG. 25A, the negative electrodes according to Comparative Example, Experimental Example 1, and Experimental Example 2 were analyzed for Mo3d through X-ray photoelectron spectroscopy (XPS). Referring to FIG. 25B, the negative electrodes according to Comparative Example, Experimental Example 1, and Experimental Example 2 were analyzed for Zn2P through the XPS. Referring to FIG. 25C, an area for each peak of a Mo3d region analyzed in FIG. 25A was quantified and shown in a graph. Referring to FIG. 25D, an area for each peak of a Zn2P region analyzed in FIG. 25B was quantified and shown in a graph.

As shown in FIGS. 25A to 25D, unlike the negative electrode according to Comparative Example, the negative electrodes according to Experimental Example 1 and Experimental Example 2 had three oxidation numbers (Mo⁺⁵, Mo, and Mo⁺⁶) for Mo, which is a central metal of the POM, due to the POM in the negative electrode. In addition, an intensity of binding energy for the oxidation number was high in an order of Mo⁺⁵, Mo, and Mo⁺⁶.

In addition, in the POM according to Experimental Example 1, an area proportion of Mo⁺⁵ was 15%, an area proportion of Mo was 42.5%, and an area proportion of Mo⁺⁶ was 42.5%. In addition, in the POM according to Experimental Example 2, an area proportion of Mo⁺⁵ was 1.8%, an area proportion of Mo was 43.1%, and an area proportion of Mo⁺⁶ was 21.8%.

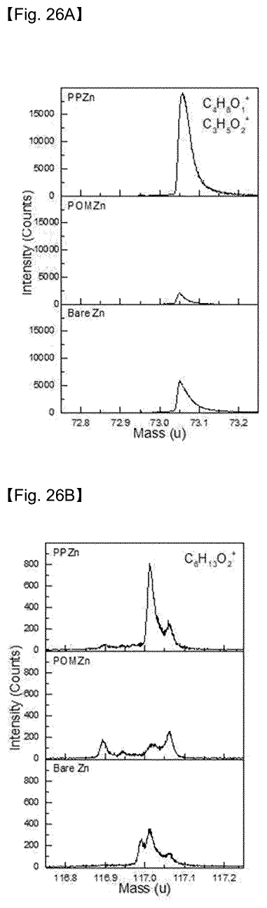

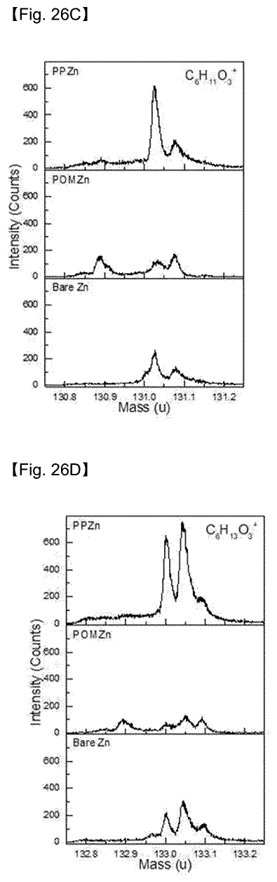

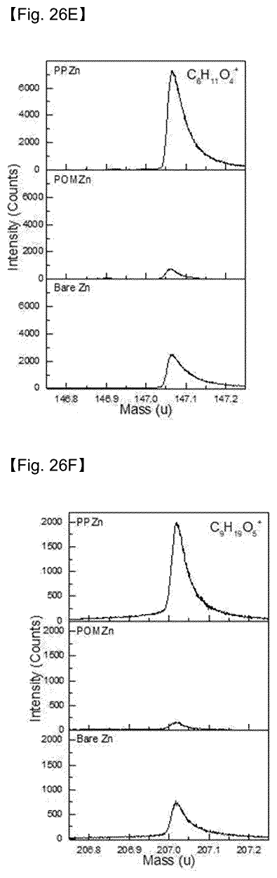

FIGS. 26A to 26F are graphs for analyzing the negative electrodes according to Comparative Example and Experimental Examples of the present invention through secondary ion mass spectrometry (SIMS).

Referring to FIGS. 26A to 26F, in order to identify presence or absence of a polymer chain constituting PEGDME in the negative electrodes according to Comparative Example, Experimental Example 1, and Experimental Example 2, the negative electrodes according to Comparative Example, Experimental Example 1, and Experimental Example 2 were analyzed through secondary ion mass spectrometry (SIMS).

As shown in FIGS. 26A to 26F, a peak of the polymer chain constituting the PEGDME, which is an ion conductive polymer, was identified only in the negative electrode according to Experimental Example 1.

Although the exemplary embodiments of the present invention have been described in detail above, the scope of the present invention is not limited to a specific embodiment, and shall be interpreted by the appended claims. In addition, it is to be understood by a person having ordinary skill in the art that various changes and modifications can be made without departing from the scope of the present invention.

What is claimed is:

1. A method for manufacturing a negative electrode, the method comprising:
preparing a metal electrode, polyoxometalate (POM), and a solvent;
preparing a composite coating layer source solution by mixing the POM and the solvent; and
preparing a composite coating layer by providing and drying the composite coating layer source solution on the metal electrode.

2. The method of claim 1, wherein the solvent includes an ion conductive polymer and deionized water, and
a volume ratio of the ion conductive polymer and the deionized water is greater than 1.5:1 and less than 9:1.

3. The method of claim 2, wherein a weight of the POM per a volume of the solvent is greater than 300 g/L and less than 500 g/L.

4. The method of claim 1, wherein the POM includes one of molybdenum (Mo), tungsten (W), or vanadium (V).

5. The method of claim 1, wherein the solvent includes one of polyethylene glycol dimethyl ether, polyacrylonitrile, poly DOL, polyamide, polyacrylic acid, or polyphthalocyanine.

6. The method of claim 1, wherein the metal electrode includes one of zinc (Zn), lithium (Li), sodium (Na), magnesium (Mg), potassium (K), or calcium (Ca).

7. A negative electrode comprising:
a metal electrode; and
a composite coating layer formed on the metal electrode,
wherein the composite coating layer includes a polymer matrix and polyoxometalate (POM) dispersed in the polymer matrix.

8. The negative electrode of claim 7, wherein, when X-ray photoelectron spectroscopy (XPS) measurement for the POM of the composite coating layer is performed, a proportion of an ion of a central metal of the POM, which has a second oxidation number that is higher than a first oxidation number, is higher than a proportion of an ion of the central metal of the POM, which has the first oxidation number.

9. The negative electrode of claim 8, wherein the central metal of the POM is molybdenum (Mo),
the first oxidation number is +5, and
the second oxidation number is +6.

10. The negative electrode of claim 8, wherein the POM has one structure among a Keggin structure, a Dawson structure, or an Anderson structure.

11. The negative electrode of claim 7, wherein, when three-dimensional microscopy measurement for the composite coating layer is performed, an arithmetic mean height (Sa) value corresponding to surface roughness of the composite coating layer is less than or equal to 0.629 um.

12. A secondary battery comprising:
the negative electrode according to claim 7;
a positive electrode formed on the negative electrode; and
an electrolyte formed between the negative electrode and the positive electrode,
wherein, during a charging/discharging process, due to plating and stripping of a metal ion of a same type as the metal electrode of the negative electrode, a metallization layer obtained by the plating of the metal ion is formed on the metal electrode, and a passivation layer is formed on the metallization layer, and
the metallization layer and the passivation layer include the POM and the polymer matrix of the composite coating layer.

13. The secondary battery of claim 12, wherein, during plating and stripping processes of the metal ion, formation of dendrite on the metal electrode is suppressed.
